(19) United States
(12) Patent Application Publication
(10) Pub. No.: US 2015/0219520 A1
(43) Pub. Date: Aug. 6, 2015

(54) Oil Leakage Sensing Composition and Oil Leakage Sensor Comprising the Same

(71) Applicants: Hong Geun YU, (US); YUMIN SYSTEM TECHNOLOGY CO., LTD., Gyeonggi-do (KR)

(72) Inventor: Hong Geun Yu, Gyeonggi-do (KR)

(73) Assignees: Hong Geun YU, Gyeonggi-do (KR); YUMIN SYSTEM TECHNOLOGY CO., LTD., Gyeonggi-do (KR)

(21) Appl. No.: 14/233,077

(22) PCT Filed: Dec. 17, 2013
(86) PCT No.: PCT/KR2013/011687

§ 371 Date: Jan. 15, 2014

(30) Foreign Application Priority Data
Jul. 2, 2013 (KR) 10-2013-0077127
Jul. 2, 2013 (KR) 10-2013-0077157
Dec. 10, 2013 (KR) 10-2013-0152835

(51) Int. Cl. G01M 3/16; H01B 1/24

(52) U.S. Cl. CPC G01M 3/16; H01B 1/24

(57) ABSTRACT

The present invention provides an oil leakage sensing composition comprising a mixture, which rapidly reacts with leaking oil upon contact with the oil to change its electrical resistance, and an oil leakage sensor comprising an electrically conductive line formed of the composition on a base film. The oil leakage sensing composition comprises a mixture of 70-85 parts by weight of a dispersion of carbon nanotubes (CNTs), 3-15 parts by weight of an alkyd resin, and 5-15 parts by weight of silver flakes. The oil leakage sensor comprises a tape-shaped base film layer, and at least one electrically conductive line printed on the upper surface of the base film layer in the length direction, wherein the electrically conductive line is formed by applying the composition to the base film layer by a printing process.

### BACKGROUND OF THE INVENTION

1. Field of the Invention

The present invention relates to an oil leakage sensing composition and an oil leakage sensor comprising the same, and more particularly to an oil leakage-sensing composition and an oil leakage sensor, which respond to leaking hydraulic oil, insulation oil and lubricating oil.

2. Description of the Prior Art

Korean Patent Laid-Open Publication No. 10-2011-0007501 filed by the applicant discloses an oil leakage sensing device that has a tape shape, and thus can be easily attached directly to a portion at which oil leakage is expected. In addition, the tape-shaped sensing device can be simply installed without having to use a separate bracket and can be cut to a desired length for use.

This oil leakage sensing device comprises: a tape-shaped base film layer; an electrically conductive line printed on the upper surface of the base film layer in the length direction of the base film layer; an electrically conductive polymer line attached to the upper surface of the base film layer so as to be parallel to the electrically conductive line; and an upper protective film layer attached to the upper surface of the base film layer and having a plurality of holes formed at a predetermined distance in the length direction.

Thus, when oil leakage occurred, the leaked oil flows into the base layer through the holes of the protective film layer, and the conductive polymer line swells in response to the oil, thus increasing its electrical resistance while increasing its volume. In this way, whether oil leakage occurred can be sensed.

Herein, the electrically conductive polymer line is formed by injection molding and is attached to the base film. For attachment, the formed conductive polymer line is placed on the base film, and then is spread with pressing with a tool.

However, in the case in which the conductive polymer line is attached while spreading it on the base film, there are problems in that the electrically conductive polymer line is easily peeled off from the base film due to its low adhesion is not uniformly formed. The biggest problem in this case is that the response speed of the electrically conductive polymer is very slow.

In other words, the speed of penetration of oil into the holes of the electrically conductive polymer line is very slow so that the response speed of the conductive polymer is very slow. Thus, the tape-shaped sensing device cannot sufficiently function as an oil leakage sensor that should generate an immediate signal when oil leakage occurs.

### SUMMARY OF THE INVENTION

Accordingly, the present invention has been made in view of the above-described problems occurring in the prior art, and it is an object of the present invention to provide an oil leakage sensing composition comprising a mixture, which quickly reacts with an oil such as hydraulic oil or insulation oil upon contact with the oil to change its electrical resistance, and an oil leakage sensor comprising an electrically conductive line formed of the composition on a base film.

Another object of the present invention is to provide an oil leakage sensing composition, which is dissolved by rapid reaction with an oil such as lubricating oil upon contact with the oil to form a short-circuit between a pair of electrically conductive lines formed on a base film, and an oil leakage sensor comprising the oil leakage sensing composition.

An oil leakage sensing composition according to an embodiment of the present invention comprises a mixture of 70-85 parts by weight of a dispersion of carbon nanotubes (CNTs), 3-15 parts by weight of an alkyd resin and 5-15 parts by weight of silver flakes.

An oil leakage sensor according to an embodiment of the present invention comprises: a tape-shaped base film layer; and an electrically conductive line formed on the upper surface of the base film layer in the length direction of the base film layer, wherein the electrically conductive line is formed by applying a mixture comprising 70-85 parts by weight of a dispersion of carbon nanotubes (CNTs), 3-15 parts by weight of an alkyd resin and 5-15 parts by weight of silver flakes to the base film layer by a printing process.

An oil leakage sensing composition according to another embodiment of the present invention comprises 45-55 parts by weight of aqueous polystyrene, 45-55 parts by weight of a nonionic surfactant, and small amounts of a wetting agent and ethyl acetate or cellosolve acetate.

An oil leakage sensor according to another embodiment of the present invention comprises: a tape-shaped base film layer; a pair of electrically conductive lines printed on an upper surface of the base film layer in the length direction of the base film layer; and a coating layer formed by coating a mixture comprising 45-55 parts by weight of aqueous polystyrene and 45-55 parts by weight of a nonionic surfactant on the upper surface of the electrically conductive lines by a printing process.

### BRIEF DESCRIPTION OF THE DRAWINGS

The above and other objects, features and advantages of the present invention will be more clearly understood from the following detailed description taken in conjunction with the accompanying drawing, in which:

FIG. 1 is a perspective view showing the exploded structure of an oil leakage sensor according to an embodiment of the present invention;

FIG. 2 is a perspective view showing the combined structure of the oil leakage sensor of FIG. 1; and

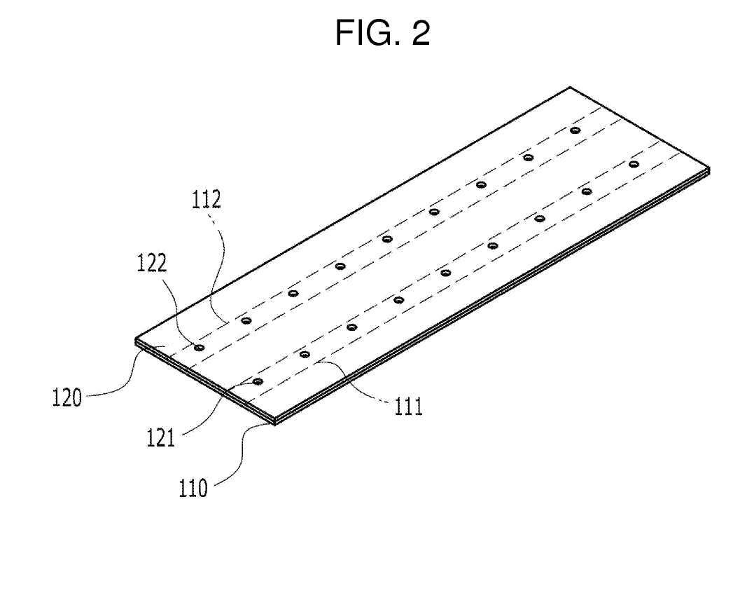

FIG. 3 is a perspective view showing the structure of an oil leakage sensor according to another embodiment of the present invention.

### DETAILED DESCRIPTION OF THE INVENTION

Hereinafter, the present invention will be described in detail with reference to the accompanying drawings.

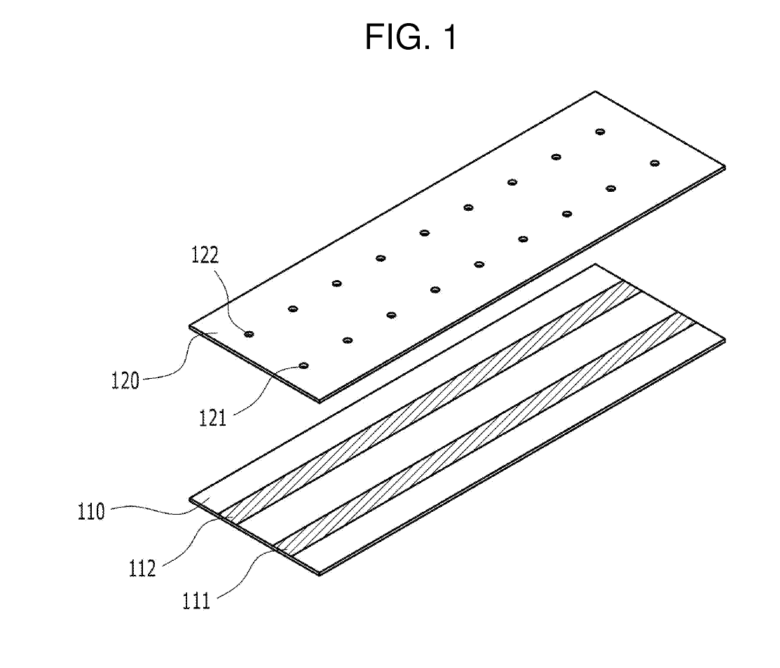

FIG. 1 is a perspective view showing the exploded structure of a sensor for sensing leakage of an oil such as hydraulic oil or insulation oil according to an embodiment of the present invention. As shown in FIG. 1, the oil leakage sensor comprises a base layer 110 made of PET, PE, PTFE, PVC or a Teflon-based film material 110, and an upper protective layer 120 laminated over the base layer 110.

On the upper surface of the base layer 110, a pair of electrically conductive lines 111 and 112 having a strip shape are disposed in parallel at a distance from each other in the length direction of the base layer 110. The electrically conductive lines are formed by printing a material, the electrical resistance of which changes in response to an oil such hydraulic oil or insulation oil, on the base layer.

The upper protective layer 120 is laminated over the electrically conductive layer 110 and serves to protect the electrically conductive lines 111 and 112 from external stimuli. The upper protective layer 120 is formed of PET, PE, PTFE, PVC or a Teflon-based material, like the base layer 110. At different positions of the electrically conductive lines 111 and 112, sensing through-holes 121 and 122 are formed at a predetermined distance from each other.

Meanwhile, each of the electrically conductive lines 111 and 112 is made of a composition comprising a mixture of 70-85 parts by weight of a dispersion of carbon nanotubes (CNTs), 3-15 parts by weight of an alkyd resin and 5-15 parts by weight of silver flakes. Herein, the composition may further comprise small amounts of a wetting agent for reducing the surface tension of the electrically conductive lines, and ethyl acetate or cellosolve acetate for volatilizing a solvent during printing.

The CNT dispersion is a paste composed of a mixture of 1-5 parts by weight of CNT powder, 90-98 parts by weight of an ethyl cellosolve solvent and 1-5 parts by weight of a nonionic surfactant-based dispersant. The ethyl cellosolve solvent and the nonionic surfactant-based dispersant serve to stabilize the structure of carbon nanotubes (CNTs) and make particles uniform.

The alkyd resin is a material that is dissolved by reaction with an oil such as hydraulic oil or insulation oil, and the silver flakes serve to increase the electrical conductivity of the oil leakage sensor of the present invention when the oil leakage sensor is installed at a long distance of 50-100 m.

The wetting agent serves to reduce the surface tension of the electrically conductive lines 111 and 112 when forming the electrically conductive lines 111 and 112 on the base layer 110 using the composition of the present invention by a printing process.

If the surface tension is too high, the composition will agglomerate without spreading when printing the electrically conductive lines 111 and 112, and the adhesion of the conductive lines to the base layer 110 will decrease and the electrical conductivity of the conductive lines will be non-uniform.

For this reason, the wetting agent is added in order to the surface tension.

In addition, a small amount of volatile ethyl acetate or cellosolve acetate is further added to the composition in order to volatilize the solvent during printing of the conductive lines 111 and 112 to impart a desired electrical conductivity to the conductive lines and increase the adhesion of the conductive lines, thereby improving the physical properties of the conductive lines 111 and 112.

Thus, this mixture is printed in a strip form on the surface of the base layer 110 to form conductive lines 111 and 112, and the upper protective layer 120 having sensing holes 121 and 122 is laminated thereon.

Thus, when leakage of an oil such as hydraulic oil or insulation oil occurs, the leaked oil will flow into the conductive lines 111 and 112 through the sensing holes 121 and 122 to increase the electrical resistance of the conductive lines 111 and 112.

When oil leakage occurs, the alkyd resin contained in the mixture will be dissolved by reaction with oil so that the conductive lines will be broken to increase their electrical resistance.

Therefore, a remote controller will receive the change in electrical resistance of the conductive layers to determine whether oil leakage occurred.

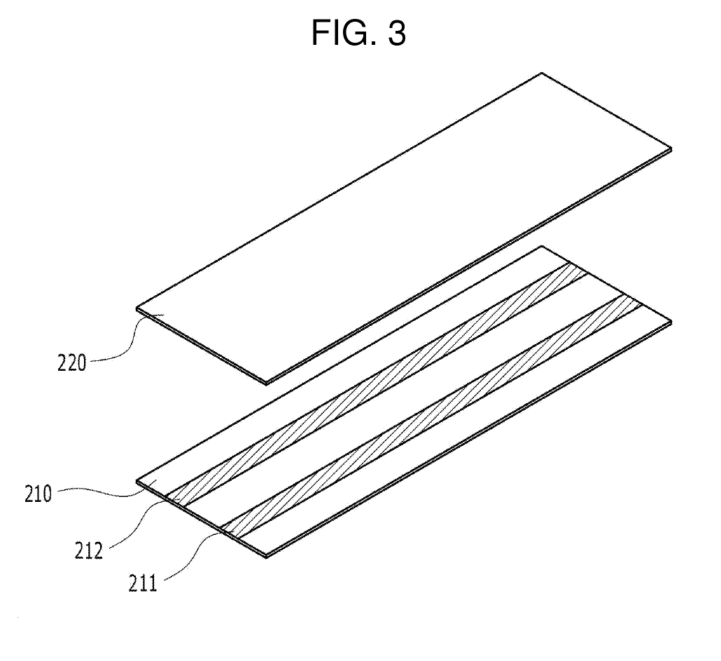

FIG. 3 is a perspective view showing a sensor for sensing leakage of an oil such as lubricating oil according to another embodiment of the present invention. As shown in FIG. 3, the oil leakage sensor comprises a base layer 210 made of PET, PE, PTFE, PVC or a Teflon-based film material, and an upper protective layer 220 laminated over the base layer 210.

On the upper surface of the base layer 210, a pair of electrically conductive lines 211 and 212 are disposed in parallel at a distance from each other in the length direction of the base layer 210. Such electrically conductive lines 211 and 212 are formed by printing an electrically conductive silver compound ink on the base layer 210.

On the upper surface of the conductive lines 211 and 212 and the entire upper surface of the base layer 210, a coating layer 220 that is dissolved by reaction with oils such as lubricating oil is formed by a printing process.

Meanwhile, each of the electrically conductive lines 211 and 212 is formed of a composition comprising a mixture of 45-55 parts by weight of aqueous polystyrene and 45-55 parts by weight of a nonionic surfactant. Herein, the composition may further comprise small amounts of a wetting agent for reducing the surface tension of the electrically conductive lines, ethanol for volatilizing a solvent during printing, and graphene that is a kind of carbon nanotube.

The aqueous polystyrene is a material that is easily dissolved by acid, and the nonionic surfactant is a material that reacts with lubricating oil and is easily dissolved when lubricating oil comes into contact with the coating layer 220.

The wetting agent serves to reduce the surface tension of the conductive layers when forming the coating layer 220 using the composition of the present invention by a printing process. If the surface tension is too high, the material of the coating layer 220 will agglomerate without spreading upon printing of the coating layer 220, and thus the adhesion of the coating layer 220 to the base layer 210 or the conductive lines 211 and 212 will decrease.

For this reason, the wetting agent is added to the composition in order to reduce the surface tension of the conductive lines.

In addition, small amounts of volatile ethanol and graphene are added in order to volatilize the solvent of aqueous polystyrene upon printing of the coating layer 220, thereby increasing the adhesion of the coating layer 220.

Thus, the coating layer 220 is formed either by applying the mixture to the entire upper surface of the base layer 210 having the conductive lines 211 and 212 formed thereon using a printing process or by applying the mixture only to the conductive lines 211 and 212.

Thus, when leakage of an oil such as lubricating oil occurs, a portion of the coating layer 220, which corresponds to a position at which the oil leakage occurred, will be dissolved to expose the electrically conductive lines 211 and 212, and the two conductive lines 211 and 212 will be short-circuited by the leaked oil. Based on the conductive state of the conductive lines 211 and 212, a controller can determine whether oil leakage occurred.

As described above, the oil leakage sensing composition and oil leakage sensor of the present invention can quickly respond to leaking oil such as hydraulic oil, insulation oil or lubricating oil, and thus can immediately sense oil leakage. Accordingly, the present invention makes it to quickly detect the fire or soil or water contamination caused by oil leakage and to take a suitable measure against the fire or soil or water contamination.

Although the preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An oil leakage sensing composition comprising a mixture of 70-85 parts by weight of a dispersion of carbon nanotubes (CNTs), 3-15 parts by weight of an alkyd resin, and 5-15 parts by weight of silver flakes.

2. The composition of claim 1, further comprising small amounts of a wetting agent and ethyl acetate or cellosolve acetate.

3. The composition of claim 1, wherein the dispersion of CNTs is composed of a mixture of 1-5 parts by weight of CNT powder, 90-98 parts by weight of an ethyl cellosolve solvent, and 1-5 parts by weight of a nonionic surfactant-based dispersant.

4. An oil leakage sensor comprising: a tape-shaped base film layer; and at least one electrically conductive line printed on an upper surface of the base film layer in a length direction of the base film layer, wherein the electrically conductive line is formed by applying a mixture comprising 70-85 parts by weight of a dispersion of carbon nanotubes (CNTs), 3-15 parts by weight of an alkyd resin, and 5-15 parts by weight of silver flakes to the base film layer by a printing process.

5. The method of claim 4, wherein the mixture further comprises a wetting agent for reducing a surface tension of the electrically conductive line, and ethyl acetate or cellosolve acetate for volatilizing a solvent during the printing process.

6. The method of claim 4, wherein the dispersion of CNTs is composed of a mixture of 1-5 parts by weight of CNT powder, 90-98 parts by weight of an ethyl cellosolve solvent, and 1-5 parts by weight of a nonionic surfactant-based dispersant.

7. An oil leakage sensing composition comprising a mixture of 45-55 parts by weight of aqueous polystyrene and 45-55 parts by weight of a nonionic surfactant.

8. The oil leakage sensing composition of claim 7, further comprising small amounts of a wetting agent, ethanol and graphene.

9. An oil leakage sensor comprising: a tape-shaped base film layer; a pair of electrically conductive lines printed on an upper surface of the base film layer in a length direction of the base film layer; and a coating layer formed by coating a mixture comprising 45-55 parts by weight of aqueous polystyrene and 45-55 parts by weight of a nonionic surfactant on an upper surface of the electrically conductive lines by a printing process.

10. The oil leakage sensor of claim 9, wherein the mixture further comprises small amounts of a wetting agent for reducing a surface tension of the electrically conductive line, ethanol for volatilizing a solvent during the printing process, and graphene that is a kind of carbon nanotube.
